(19) United States
(12) Patent Application Publication
(10) Pub. No.: US 2022/0068547 A1
(43) Pub. Date: Mar. 3, 2022

(54) INDUCTANCE DEVICE

(71) Applicant: CHILISIN ELECTRONICS CORP., HSINCHU COUNTY (TW)

(72) Inventor: MING-CHIEH CHIU, TAOYUAN CITY (TW)

(21) Appl. No.: 17/402,717

(22) Filed: Aug. 16, 2021

(30) Foreign Application Priority Data
Sep. 3, 2020 (TW) 109130184

(51) Int. Cl. H01F 27/28; H01F 27/29; H01F 27/32; H01F 41/12; H01F 41/04

(52) U.S. Cl. CPC H01F 27/2804; H01F 27/29; H01F 2027/2809; H01F 41/12; H01F 41/041; H01F 27/32

(57) ABSTRACT

An inductance device is provided. The inductance device includes a laminated body, a plurality of conductive fillers, a first external electrode, and a second external electrode. The laminated body includes a plurality of insulators and patterned conductors alternately stacked. The laminated body has a bottom surface, a top surface, a first side surface, and a second side surface, the latter two of which are both connected between the bottom and top surface. The conductive fillers distributed in the insulators each pass through corresponding one of the insulators to connect two adjacent ones of the patterned conductors and form a spirally coiled conductor. The first and second external electrodes are respectively formed at the first and second side surfaces. Inner surfaces of the first and second external electrode are respectively connected to uppermost and lowermost ones of the patterned conductors, and are curved surfaces.

### CROSS-REFERENCE TO RELATED PATENT APPLICATION

This application claims the benefit of priority to Taiwan Patent Application No. 109130184, filed on Sep. 3, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an inductance device, and more particularly to an inductance device in which a connecting position between an external and internal electrodes thereof is modified.

### BACKGROUND OF THE DISCLOSURE

In a conventional inductive device, an inductance value and a Q value of the inductive device are usually affected by where a connecting point between an inner conductor and an external electrode is located. The Q value is a quality factor, and represents a ratio of an inductive resistance to direct current (DC) resistance of the coil (i.e., an inner conductor) during the operation of the coil under an alternating current (AC) voltage at a certain frequency. The higher the Q value of the inductive device is, the less the loss of the inductive device is, and the higher the efficiency the inductive device has. The quality factor (the Q value) is an important indicator when determining the quality of the coil, and increasing the Q value is one of the key points to be considered when the coil is wound.

In a conventional technology, a connection section of the coil (the inner conductor) of the inductive device for connecting the external electrode usually straightly extends along a horizontal direction and is connected to the external electrode or extends along a normal direction of the outer edge of the coil and is connected to the external electrode. However, when the connection section of the coil extends linearly along the horizontal direction and is connected to the external electrode, a return loss is generated due to the connection section being perpendicularly connected to the external electrode, thereby reducing the inductance value and the Q value. When the connection section extends along the normal direction of the outer edge of the coil and is connected to the external electrode, the fabrication cost of the coil is increased due to the extension distance of the connection section being too long.

Accordingly, how the connecting position between the external electrode and the inner conductor in the inductive device can be further modified by another different structural design so as to overcome the abovementioned shortages has become one of the issues to be solved in the related art.

### SUMMARY OF THE DISCLOSURE

In response to the above-referenced technical inadequacies, the present disclosure provides an inductance device, which includes a laminated body, a plurality of conductive fillers, a first external electrode, and a second external electrode. The laminated body includes a plurality of insulators and a plurality of patterned conductors that are alternately stacked. The laminated body has a bottom surface, a top surface opposite to the bottom surface, a first side surface, and a second side surface opposite to the first side surface, and the first and second side surfaces are both connected between the bottom surface and the top surface. Each of the patterned conductors in the laminated body is located at an interface between two adjacent ones of the insulators, and extends along a surrounding trace. The conductive fillers are distributed in the plurality of insulators. Each of the conductive fillers passes through corresponding one of the insulators along a thickness direction thereof so as to connect two adjacent ones of the pattered conductors and form a spirally coiled conductor. The first external electrode and the second external electrode are respectively formed at the first side surface and the second side surface of the laminated body. An inner surface of the first external electrode is connected to an uppermost one of the patterned conductors, and an inner surface of the second external electrode is connected to a lowermost one of the patterned conductors. An outer surface of the first external electrode is exposed at the bottom surface and the first side surface of the laminated body, an outer surface of the second external electrode is exposed at the bottom surface and the second side surface of the laminated body, and the inner surfaces of the first and second external electrodes are curved surfaces.

Therefore, by virtue of “a laminated body including a plurality of insulators and a plurality of patterned conductors that are alternately stacked, in which the laminated body has a bottom surface, a top surface opposite to the bottom surface, a first side surface, and a second side surface opposite to the first side surface, the first and second side surfaces are both connected between the bottom surface and the top surface, and each of the patterned conductors in the laminated body is located at an interface between two adjacent ones of the insulators, and extends along a surrounding trace,” “a plurality of conductive fillers being distributed in the plurality of insulators, in which each of the conductive fillers passes through corresponding one of the insulators along a thickness direction thereof so as to connect two adjacent ones of the pattered conductors and form a spirally coiled conductor,” “a first external electrode and a second external electrode respectively being formed at the first side surface and the second side surface, in which an inner surface of the first external electrode is connected to an uppermost one of the patterned conductors, and an inner surface of the second external electrode is connected to a lowermost one of the patterned conductors” and “an outer surface of the first external electrode being exposed at the bottom surface and the first side surface of the laminated body, an outer surface of the second external electrode being exposed at the bottom surface and the second side surface of the laminated body, and the inner surfaces of the first and second external electrodes being curved surfaces,” the connecting positions between the inner conductors (the patterned conductors) and the external electrodes of the inductance device can be modified.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic exploded view of an inductance device according to a first embodiment of the present disclosure;

FIG. 2 is a schematic perspective view of the inductance device according to the first embodiment of the present disclosure;

FIG. 3 is another schematic perspective view of the inductance device according to the first embodiment of the present disclosure;

FIG. 4 is a schematic front view of the inductance device according to the first embodiment of the present disclosure; and

FIG. 5 is a schematic front view of the inductance device according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

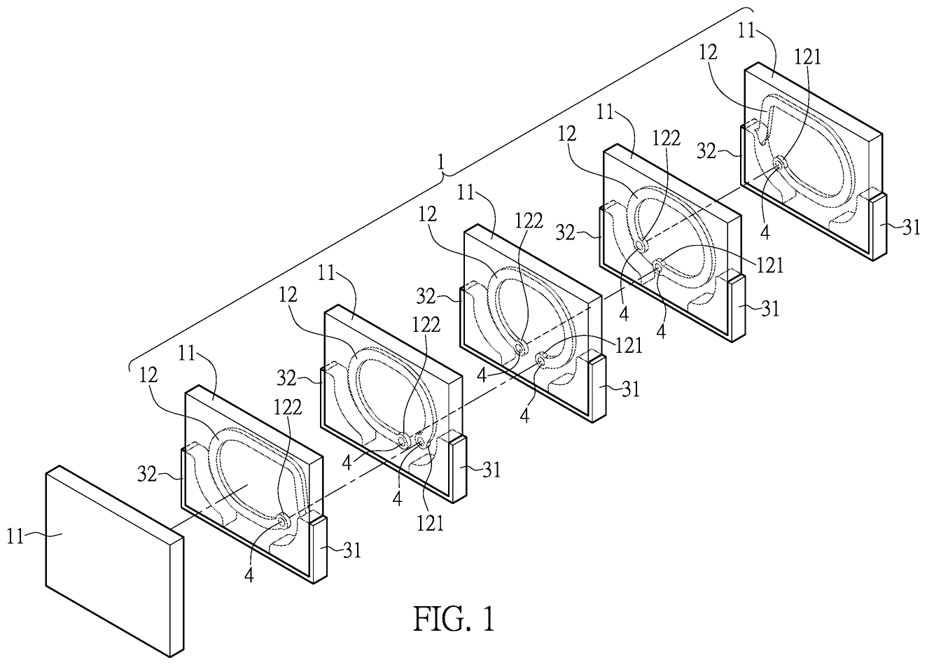

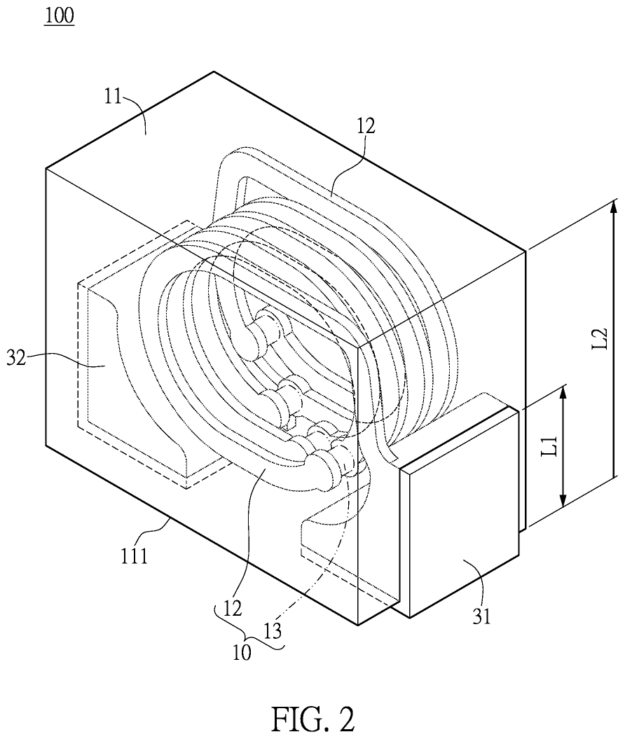

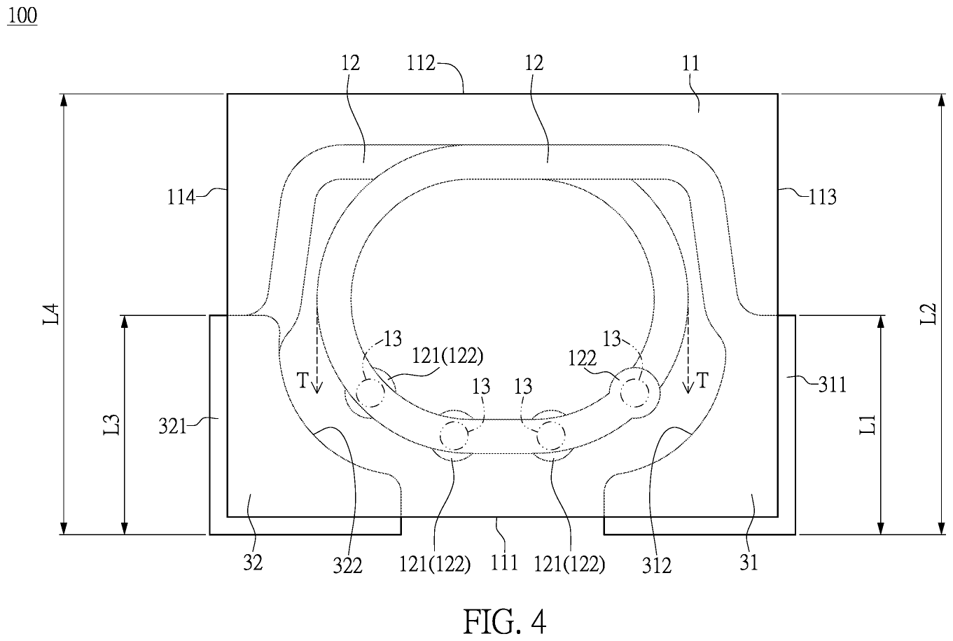

Referring to FIG. 1, FIG. 2 and FIG. 4, an inductance device 100 is provided in a first embodiment of the present disclosure. The inductance device 100 includes a laminated body 1, a plurality of conductive fillers 13, a first external electrode 31, and a second external electrode 32.

As shown in FIG. 1, the laminated body 1 includes a plurality of insulators 11 and a plurality of patterned conductors 12 that are alternately stacked. That is to say, the laminated body 1 is fabricated by successively forming one of the insulators 11, one of the patterned conductors 12, one of the insulators 11, one of the patterned conductors 12, and so on, that are stacked layer-by-layer. As shown in FIG. 2, the patterned conductors 12 are disposed in the inside of the laminated body 1 formed by layer-by-layer stacking. In other words, the insulators 11 completely enclose the patterned conductors 12. As shown in FIG. 4, from the appearance of the laminated body 1, the laminated body 1 has a bottom surface 111 and a top surface 112 that are opposite to each other, and a first side surface 113 and a second side surface 114 that are opposite to each other. Each of the first side surface 113 and the second side surface 114 is connected between the bottom surface 111 and the top surface 112.

Specifically, each of the patterned conductors 12 is located at an interface between two adjacent ones of the insulators 11, and extends along a surrounding trace. The conductive fillers 13 are distributed in the insulators 11. Each of the conductive fillers 13 passes through corresponding one of the insulators 11 along a thickness direction thereof so as to connect two adjacent ones of the patterned conductors 12, such that the patterned conductors 12 are connected to one another to form a coiled conductor 10 that extends spirally.

The first external electrode 31 and the second external electrode 32 are respectively formed at the first side surface 113 and the second side surface 114 of the laminated body 1. An inner surface 312 of the first external electrode 31 is connected to the uppermost one of the patterned conductors 12, and an inner surface 322 of the second external electrode 32 is connected to the lowermost one of the patterned conductors 12. An outer surface 311 of the first external electrode 31 is exposed at the bottom surface 111 and the first side surface 113 of the laminated body 1. An outer surface 321 of the second external electrode 32 is exposed at the bottom surface 111 and the second side surface 114 of the laminated body 1. The inner surfaces 312, 322 of the first and second external electrodes 31, 32 are curved surfaces. In other words, a connecting surface of the first external electrode 31 in contact with the laminated body 1 is a curved surface, and a connecting surface of the second external electrode 32 in contact with the laminated body 1 is a curved surface. By designing the inner surfaces 312, 322 as curved surfaces, a distance between each of the connecting surfaces of the first and second external electrodes 31, 32 that are in contact with the laminated body 1 and the laminated body 1 can be shortened, thereby reducing the fabrication cost of external electrodes.

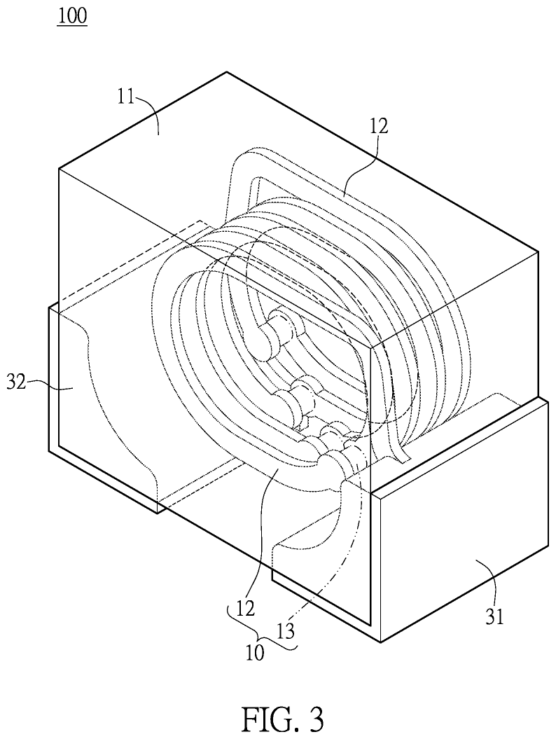

It should be noted that widths of the first external electrode 31 and the second external electrode 32 can be adjusted according to particular implementations. Reference is made to FIG. 2 and FIG. 3. The width of the first external electrode 31 can be less than that of the first side surface 113 of the laminated body 1, and the width of the second external electrode 32 can be less than that of the second side surface 114 of the laminated body 1 (as shown in FIG. 2). Alternatively, the first external electrode 31 can have the same width as that of the first side surface 113 of the laminated body 1, and the second external electrode 32 can have the same width as that of the second side surface 114 of the laminated body 1 (as shown in FIG. 3).

Furthermore, when the outer surface 311 of the first external electrode 31 has a part exposed at the first side surface 113 of the laminated body 1, the part of the outer surface 311 of the first external electrode 31 has a length L1 that is at least one third of a length L2 of the first side surface 113. Similarly, when the outer surface 321 of the second external electrode 32 has a part exposed at the second side surface 114 of the laminated body 1, the part of the outer surface 321 of the second external electrode 32 has a length L3 that is at least one third of a length L4 of the second side surface 114.

Subsequently, referring to FIG. 1 and FIG. 2, each of the patterned conductors 12 is further described in details. The patterned conductors 12 each have a first end 121 and a second end 122. For two upper and lower ones of the patterned conductors 12 that are adjacent to each other, the second end 122 of the upper one of the patterned conductors 12 is connected to the first end 121 of the lower one of the patterned conductors 12 through one of the conductive fillers 13 in the insulator 11 between the two upper and lower ones of the patterned conductors 12 that are adjacent to each other.

Reference is made to FIG. 4. When the uppermost one of the patterned conductors 12 is connected to the first external electrode 31, the first end 121 of the uppermost one of the patterned conductors 12 extends along a tangential direction T of the surrounding trace of the uppermost one of the patterned conductors 12 and is connected to the inner surface 312 of the first external electrode 31. To be more specific, the first end 121 of the uppermost one of the patterned conductors 12 extending along the tangential direction T of the surrounding trace is connected to an upper part of the inner surface 312 of the first external electrode 31, in which the upper part is closer to the first side surface 113 in the curved structure of the inner surface 312.

Similarly, when the lowermost one of the patterned conductors 12 is connected to the second external electrode 32, the second end 122 of the lowermost one of the patterned conductors 12 extends along a tangential direction T of the surrounding trace of the lowermost one of the patterned conductors 12 and is connected to the inner surface 322 of the second external electrode 32. To be more specific, the second end 122 of the lowermost one of the patterned conductors 12 extending along the tangential direction T of the surrounding trace is connected to an upper part of the inner surface 322 of the second external electrode 32, in which the upper part is closer to the second side surface 114 in the curved structure of the inner surface 322.

Reference is made to FIG. 1. A fabrication process of the inductance device provided in an embodiment of the present disclosure is described.

In the first step, a photosensitive conductive material (not shown in the figures) is coated on a continuous insulating material (not shown in the figures), and then an exposure process is performed on the photosensitive conductive material to form a plurality of patterned conductors 12 each having a first end 121 and a second end 122. The photosensitive conductive material is mainly photosensitive silver slurry, and the continuous insulating material is mainly ceramic material. Specifically, the continuous insulating material is mainly non-photosensitive ceramic slurry. The continuous insulating material can be fabricated by a roll-to-roll coating process or a printing process.

In the second step, a laser drilling process is performed on the continuous insulating material to form a plurality of through holes 4 passing there through. The insulators 11 each have one of the patterned conductors 12 and one of the through holes 4. The through holes 4 are connected to the second ends 122 of the patterned conductors 12, respectively.

In the third step, a photosensitive silver slurry is filled into each of the through holes 4, and then exposure and development processes are performed to form the conductive fillers 13.

In the fourth step, the insulators 11 are stacked with the patterned conductors 12 corresponding in position to one another, so as to form a continuous laminated body 1. During the process of stacking the insulators 11 and the patterned conductors 12, one of the conductive fillers 13 in one of the insulators 11 is connected to the first end 121 of one of the patterned conductors 12 that is formed on the adjacent lower one of the insulators 11, so that the patterned conductors 12 are connected to one another through the conductive fillers 13 to form the coiled conductor 10 that extends spirally. Subsequently, the continuous laminated body 1 is cut to form a plurality of laminated bodies 1.

In the fifth step, two external electrodes, i.e., the first external electrode 31 and the second external electrode 32, are formed at two sides of each of the laminated bodies 1. The first external electrode 31 is connected to the uppermost one of the patterned conductors 12, and the second external electrode 32 is connected to the lowermost one of the patterned conductors 12 so as to form the inductance device 100.

In conclusion, in the fabrication process of the inductance device 100 provided in the present disclosure, a plurality of green sheets (the continuous insulating materials) can be fabricated by roll-to-roll coating, and then the photosensitive silver slurry can be printed on each of the green sheets to form the pattern conductors 12. After the patterned conductors 12 are individually formed on the green sheets, the green sheets and the patterned conductors 12 formed thereon are stacked with the patterned conductors 12 corresponding in position to one another to form the laminated body 1. Finally, two external electrodes are formed at two sides of the laminated body 1, respectively, so as to form the inductance device 100. Alternatively, a non-photosensitive ceramic slurry can be printed to fabricate the continuous insulating materials, and then the photosensitive silver slurry is printed on each of the continuous insulating materials. Subsequently, exposure and development processes are performed to form the pattern conductors 12. Regardless of which of the aforementioned processes is used, the though holes 4 are formed by performing a laser drilling process, the photosensitive silver slurry is then filled into each of the through holes 4, and then exposure and development processes are performed to form the conductive fillers 13.

### Second Embodiment

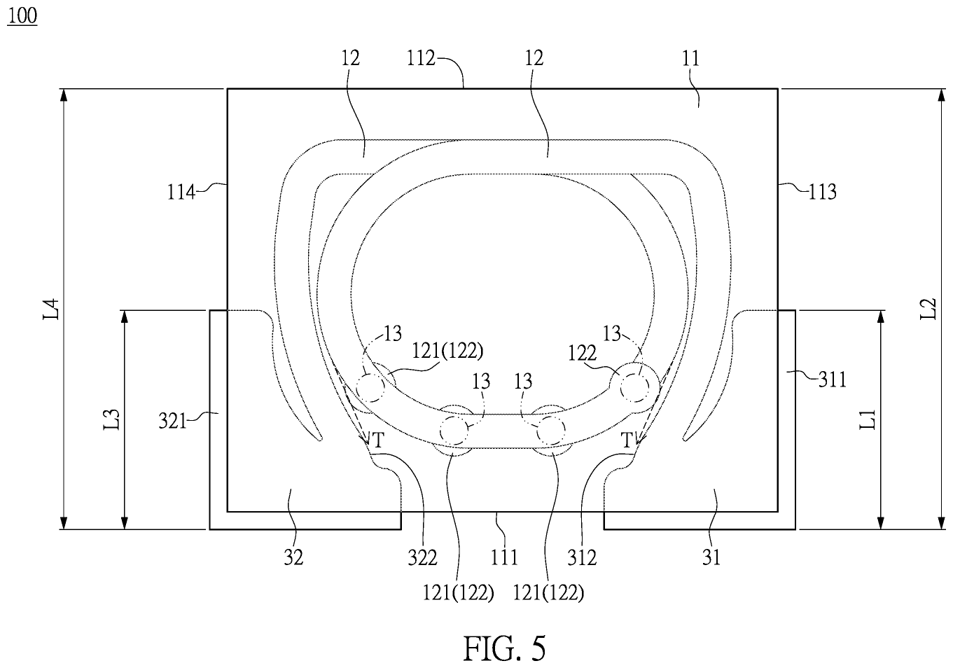

Reference is made to FIG. 5. The inductance device 100 of a second embodiment can be fabricated by the same processes as those for fabricating the inductance device 100 of the first embodiment, and the same fabrication processes will not be reiterated herein. A difference between the first embodiment and the second embodiment is that the first end 121 of the uppermost one of the patterned conductors 12 is connected to the inner surface 312 of the first external electrode 31, and a connecting position between the first end 121 of the uppermost one of the patterned conductors 12 and the inner surface 312 of the first external electrode 31 is near the bottom surface 111 of the laminated body 1. Similarly, the second end 122 of the lowermost one of the patterned conductors 12 is connected to the inner surface 322 of the second external electrode 32, and a connecting position between the second end 122 of the lowermost one of the patterned conductors 12 and the inner surface 322 of the second external electrode 32 is near the bottom surface 111 of the laminated body 1.

It should be noted that in the first and second embodiments, the first end 121 of the uppermost one of the patterned conductors 12 extends along the tangential direction T of the surrounding trace and is connected to the inner surface 312 of the first external electrode 31, and the second end 122 of the lowermost one of the patterned conductors 12 extends along the tangential direction T of the surrounding trace and is connected to the inner surface 322 of the second external electrode 32. However, it can be observed by comparing FIGS. 4 and 5 that in the first embodiment shown in FIG. 3 and FIG. 4, the connecting position between the first end 121 of the uppermost one of the patterned conductors 12 and the first external electrode 31 is located at a position of the inner surface 312 of the first external electrode 31 closer to the first side surface 113 of the laminated body 1, and the connecting position between the second end 122 of the lowermost one of the patterned conductors 12 and the second external electrode 32 is located at a position of the inner surface 322 of the second external electrode 32 closer to the second side surface 114 of the laminated body 1. In the second embodiment shown in FIG. 5, the connecting position between the first end 121 of the uppermost one of the patterned conductors 12 and the first external electrode 31 is located at a position of the inner surface 312 of the first external electrode 31 closer to the bottom surface 111 of the laminated body 1, and the connecting position between the second end 122 of the lowermost one of the patterned conductors 12 and the second external electrode 32 is located at a position of the inner surface 322 of the second external electrode 32 that is also closer to the bottom surface 111 of the laminated body 1.

### Beneficial Effects of the Embodiments

In conclusion, one of the advantages of the inductance device provided by the present disclosure is that by the technical features of “a laminated body including a plurality of insulators and a plurality of patterned conductors that are alternately stacked, in which the laminated body has a bottom surface, a top surface opposite to the bottom surface, a first side surface, and a second side surface opposite to the first side surface, the first and second side surfaces are connected between the bottom surface and the top surface, and each of the patterned conductors in the laminated body is located at an interface between two adjacent ones of the insulators, and extends along a surrounding trace,” “a plurality of conductive fillers being distributed in the plurality of insulators, in which each of the conductive fillers passes through corresponding one of the insulators along a thickness direction thereof so as to connect two adjacent ones of the pattered conductors and form a spirally coiled conductor,” “a first external electrode and a second external electrode being respectively formed at the first side surface and the second side surface, in which an inner surface of the first external electrode is connected to an uppermost one of the patterned conductors, and an inner surface of the second external electrode is connected to a lowermost one of the patterned conductors” and “an outer surface of the first external electrode being exposed at the bottom surface and the first side surface of the laminated body, an outer surface of the second external electrode being exposed at the bottom surface and the second side surface of the laminated body, and the inner surfaces of the first and second external electrodes being curved surfaces,” the connecting positions between the inner conductors (the patterned conductors) and the external electrodes of the inductance device can be modified.

To be more specific, in the conventional inductive device, the connection section of the coil (the inner conductor) usually straightly extends along a horizontal direction to the external electrode or extends along a normal direction of the outer edge of the coil to the external electrode, which may easily result in a lower inductance value or a lower Q value or high fabrication cost of the coil. In the inductance device provided in the present disclosure, the inner surface of the external electrode is modified to be in a curved shape, and a connection end of the patterned conductor extends along a tangential direction T of the surrounding trace of the patterned conductor to be connected to an upper part of an inner surface of the external electrode (that is near the first side surface or second side surface of the laminated body) or to be connected to a lower part of an inner surface of the external electrode (that is near the bottom surface of the laminated body). By modifying the structure of the inductance device provided in the present disclosure, a distance between one of the patterned conductor (the inner conductor) and the external electrode can be shortened, the fabrication cost of the coil can be reduced, and the inductance value and the Q value of the inductance device are not negatively impacted, thereby taking into account both the fabrication cost and efficiency of the inductance device.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An inductance device, comprising:
a laminated body including a plurality of insulators and a plurality of patterned conductors that are alternately stacked, wherein the laminated body has a bottom surface, a top surface opposite to the bottom surface, a first side surface, and a second side surface opposite to the first side surface, the first and second side surfaces are both connected between the bottom surface and the top surface, and each of the patterned conductors in the laminated body is located at an interface between two adjacent ones of the insulators and extends along a surrounding trace;
a plurality of conductive fillers distributed in the plurality of insulators, wherein each of the conductive fillers passes through a corresponding one of the insulators along a thickness direction thereof so as to connect two adjacent ones of the pattered conductors and form a coiled conductor that extends spirally; and
a first external electrode and a second external electrode respectively formed at the first side surface and the second side surface of the laminated body, wherein an inner surface of the first external electrode is connected to an uppermost one of the patterned conductors, and an inner surface of the second external electrode is connected to a lowermost one of the patterned conductors;
wherein an outer surface of the first external electrode is exposed at the bottom surface and the first side surface of the laminated body, an outer surface of the second external electrode is exposed at the bottom surface and the second side surface of the laminated body, and the inner surfaces of the first and second external electrodes are curved surfaces.

2. The inductance device according to claim 1, wherein the patterned conductors each have a first end and a second end, and for two upper and lower ones of the patterned conductors that are adjacent to each other, the second end of the upper one of the patterned conductors is connected to the first end of the lower one of the patterned conductors through one of the conductive fillers.

3. The inductance device according to claim 2, wherein the uppermost one of the patterned conductors is connected to the first external electrode, and the first end of the uppermost one of the patterned conductors extends along a tangential direction of the surrounding trace of the uppermost one of the patterned conductors and is connected to the inner surface of the first external electrode.

4. The inductance device according to claim 2, wherein the lowermost one of the patterned conductors is connected to the second external electrode, and the second end of the lowermost one of the patterned conductors extends along a tangential direction of the surrounding trace of the lowermost one of the patterned conductors and is connected to the inner surface of the second external electrode.

5. The inductance device according to claim 2, wherein the first end of the uppermost one of the patterned conductors is connected to the inner surface of the first external electrode, and a connecting position between the first end of the uppermost one of the patterned conductors and the inner surface of the first external electrode is near the bottom surface of the laminated body.

6. The inductance device according to claim 2, wherein the second end of the lowermost one of the patterned conductors is connected to the inner surface of the second external electrode, and a connecting position between the second end of the lowermost one of the patterned conductors and the inner surface of the second external electrode is near the bottom surface of the laminated body.

7. The inductance device according to claim 1, wherein the outer surface of the first external electrode has a part exposed at the first side surface of the laminated body, the part of the outer surface of the first external electrode has a length that is at least one third of a length of the first side surface.

8. The inductance device according to claim 1, wherein the outer surface of the second external electrode has a part exposed at the second side surface of the laminated body, the part of the outer surface of the second external electrode has a length that is at least one third of a length of the second side surface.

9. The inductance device according to claim 1, wherein the insulators are fabricated by roll-to-roll coating a ceramic material thereon.

10. The inductance device according to claim 1, wherein the insulators are fabricated by printing a non-photosensitive ceramic slurry thereon.

11. The inductance device according to claim 1, wherein each of the conductive fillers are fabricated by using a laser beam to drill a through hole in one of the insulators, filling a photosensitive silver slurry into the through hole, and performing exposure and development processes.
